(19) United States
(12) Patent Application Publication
(10) Pub. No.: US 2026/0307956 A1
(43) Pub. Date: Oct. 8, 2026

(54) AIR HOIST, PARTICULARLY ADAPTED FOR USE IN A SHIPYARD

(71) Applicant: Ingersoll-Rand Equipements De Production, Sin-Le-Noble (FR)

(72) Inventors: Arnaud Bruneel, Herlies (FR); Alexis Flipo, Villenevue d'Asq (FR); Mateo Rinaldi, Douai (FR); Sebastien Duhamel, Harnes (FR)

(21) Appl. No.: 19/641,993

(22) Filed: Apr. 8, 2026

(30) Foreign Application Priority Data
Apr. 8, 2025 (FR) 2503715

(51) Int. Cl. B66D 3/20

(52) U.S. Cl. CPC B66D 3/20

(57) ABSTRACT

The disclosure relates to an air hoist, particularly adapted for use in a shipyard, wherein the air hoist comprises an air hoist body with a pneumatic motor and a cable or chain for connecting a load, the pneumatic motor having an air intake and an air outlet for respectively letting in and letting out compressed air, the pneumatic motor being adapted to move said cable or chain with respect to the air hoist body, wherein the air hoist comprises a control unit with an air entry, the control unit being adapted to guide compressed air from said air entry toward the air inlet of the pneumatic motor, the control unit comprising an air filter positioned downstream from the air entry and upstream from the air inlet of the pneumatic motor.

### TECHNICAL FIELD

The present disclosure relates to an air hoist, particularly to an air hoist adapted for use in a shipyard.

### BACKGROUND

Air hoists are used, for instance, at locations where traditional cranes cannot be used.

An example of air hoist use is in a shipyard for the construction and/or repair of a ship. Typically, when a ship is in a dry dock, the space under the ship hull is not accessible for a crane. One solution to lifting objects under the ship hull is to fix a temporary lug to the hull and then attach an air hoist to the lug to lift or lower objects.

An air hoist typically comprises a hoist body with an air-operated motor powered by compressed air. The pneumatic motor is connected to a cable or chain and adapted to raise or lower said cable or chain. The hoist body is further provided with a connecting element, such as a hook, to attach the hoist body to a support, like a temporary lug.

The chain of an air hoist comprises a hook or similar connecting element to connect an object or load. Using an air hoist, an object or load can be raised or lowered with compressed air.

One advantage of using an air hoist is that the device is relatively simple in construction and therefore relatively cheap to produce and operate. The weight of an air hoist is much lower than that of an electric hoist, making it easier for the user to handle. Moreover, air hoists are also more compact than electric hoists. In use at shipyards, air hoists can therefore be operated closer to the hull surface, avoiding interference between the hoist body and the hull.

A further important advantage of air hoists is that they are ideal for use in areas without an electric power supply or where electricity could pose a hazard due to the risk of sparking.

The use of compressed air further enables variable speeds and handling, which can be used for more delicate projects and for accurate load positioning.

Air hoists are specifically adapted for use in shipyards in view of the combination of advantages mentioned above. Moreover, at shipyards, compressed air is usually readily available. At shipyards, compressed air is used for various purposes, including cleaning the hulls of ships under construction.

An air hoist is connected to a source of compressed air by means of a tube or hose. Such a hose can easily be contaminated, either by prior use of the hose or by contamination present in the area where the hose is stored.

Prior to the use of an air hoist, a user connects a first end of a hose to the source of compressed air and connects the opposite end of the hose to the air hoist. However, to allow proper use of the air hoist, a user must take protective measures to ensure that the air supplied to the air hoist is adapted for operating the pneumatic motor of the air hoist. This means that the air entering the pneumatic motor must be filtered and lubricated. To provide filtration and lubrication, the air hoist is generally used in combination with at least an air filter and a lubricator, and optionally a pressure regulator.

The air filter is needed to filter out the particles from the pressurized air that could cause the pneumatic motor to malfunction.

Compressed air lubrication for the pneumatic motor is needed to protect its moving parts from wear and rust. One reason for this lubrication is that compressed air always contains a certain amount of moisture. The presence of moisture inside the pneumatic motor, without lubrication, could cause the moving elements to fail or not function properly after a certain period of non-use of the air hoist.

A pressure regulator is used to regulate the air pressure of the compressed air available for operating the pneumatic motor to a predetermined level before allowing the air to enter the pneumatic motor.

The combination of the filter, regulator and a lubricator, as described above, is often referred to as an “FRL” unit.

An important disadvantage of known air hoists is the fact that an FRL unit (i.e., filter, regulator, lubricator) can easily be used improperly. Firstly, it is possible that a user decides not to use an FRL unit at all, or forgets to connect an FRL unit to the air hose supplying compressed air to the air hoist. Currently used air hoists do not include any safety means to prevent use without an FRL properly installed. This can lead to the air hoist being damaged.

Further, it is possible to connect the FRL unit, or any part thereof, in an improper manner. A typical mistake is to connect the lubricator too far from the pneumatic motor. This may cause the lubrication provided in the compressed air not to reach the pneumatic motor. This can cause the pneumatic motor to be damaged in use.

A further disadvantage of known air hoists is the fact that FRL units are produced and commercialized independently from the air hoists themselves. This means that customers are free to buy an air hoist from a first supplier and an FRL unit from a second supplier, but a mismatch between the air hoist and the FRL could occur, thus causing damage to the pneumatic motor of the air hoist.

A further disadvantage linked to FRL units is that the devices require space for storage and, in use, space either on or nearby the air hoist. In practise, it can be difficult to find an adapted space to fix the mentioned FRL unit to allow proper functioning thereof.

And yet another disadvantage related to existing air hoists and FRL units is the fact that, once a FRL unit is connected to an air hoist, the FRL unit forms a fragile element that can easily be damaged during transport and installation.

In view of the observations above, it is desired to provide an improved air hoist to overcome at least some of the mentioned disadvantages related to existing air hoists and FRL units.

### SUMMARY

According to embodiments disclosed herein, an air hoist is particularly adapted for use in a shipyard, wherein the air hoist comprises an air hoist body with a pneumatic motor and a cable or chain for connecting a load, the pneumatic motor having an air intake and an air outlet for respectively letting in and letting out compressed air, the pneumatic motor being adapted to move said cable or chain with respect to the air hoist body, wherein the air hoist comprises a control unit with an air entry, the control unit being adapted to guide compressed air from said air entry toward the air inlet of the pneumatic motor, the control unit comprising an air filter positioned downstream from the air entry and upstream from the air inlet of the pneumatic motor.

According to embodiments, the control unit comprises a lubrication system adapted to lubricate an air flow through the control unit.

According to embodiments, the lubrication system is positioned downstream from the filter and upstream from the air inlet of the pneumatic motor.

According to embodiments, the control unit comprises an air pressure regulator.

According to embodiments, the control unit comprises an overload protection with a first, opening position to allow the cable or chain to move with respect to the air hoist body and a second, brake position to avoid the cable or chain to move with respect to the air hoist body, the overload protection moving to its second brake position in case the tension on the cable or chain exceeds a predetermined threshold.

According to embodiments, the overload protection comprises an assembly of a piston, a cylinder and a spring, the piston being adapted to move from said first, opening position of the overload protection towards said second, brake position of the overload protection by means of pressure exerted on said piston by means of the air flow through the control unit.

According to embodiments, the control unit comprises a control valve arm adapted to move from a neutral position to either a first position to allow the pneumatic motor to turn in a first direction or a second position to allow the pneumatic motor to turn in an opposite, second direction.

According to embodiments, a control unit for an air hoist is described herein. The air hoist comprises an air hoist body with a pneumatic motor and a cable or chain for connecting a load, the pneumatic motor having an air intake and an air outlet for respectively letting in and letting out compressed air, the pneumatic motor being adapted to move said cable or chain with respect to the air hoist body, adapted to be connected to the air hoist body an is adapted to guide compressed air to the air inlet of the pneumatic motor of the air hoist, the control unit comprising an air entry, an air filter positioned downstream from the air entry and an air exit, wherein the exit of the control unit is adapted to be connected to the air inlet of the pneumatic motor of the air hoist.

According to embodiments, the control unit comprises a lubrication system adapted to lubricate an air flow through the control unit.

At least one of the above embodiments provides one or more solutions to the problems and disadvantages described herein. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment or embodiments.

### BRIEF DESCRIPTION OF THE DRAWINGS

The following drawings illustrate embodiments of the disclosure and serve to explain, by way of example, the principles of the disclosure:

FIG. 1 shows a perspective view of the air hoist according to an embodiment of the present disclosure;

FIG. 2 shows in detail a control unit for the air hoist according to an embodiment of the present disclosure; and

FIG. 3 shows a schematic representation of a lubrication device for the control unit of the air hoist according to an embodiment of the present disclosure.

### DETAILED DESCRIPTION

In the present description and in the description of the drawings, the terms “upper,” “top” and “lower” are used in combination with the verbs “lift,” “raise” and “lower.” These words refer to the elements of the air hoist and the functioning thereof in the position as shown in the drawings.

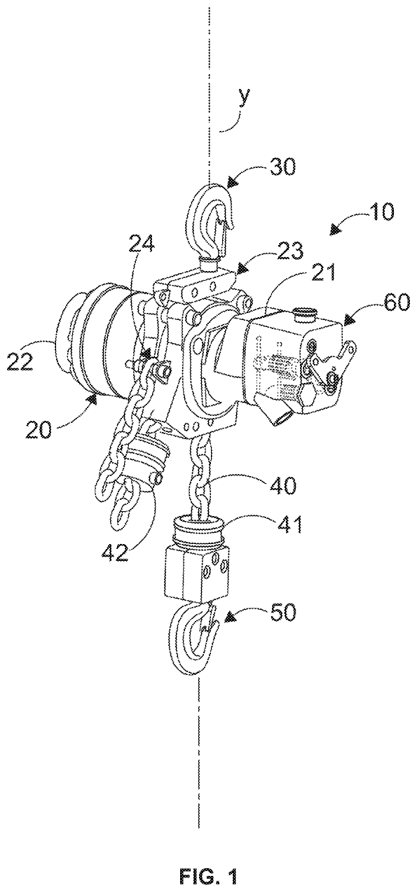

FIG. 1 shows an air hoist 10 according to an embodiment of the present disclosure, which air hoist 10 is specifically adapted to be used at shipyards.

The air hoist 10 comprises a body 20 with a first end 21 and a second end 22. The body 20 of the air hoist 10 comprises, in its interior, a pneumatic motor which is not shown in the drawing and not further described in detail.

The pneumatic motor used in the body 20 of the air hoist 10 is typically adapted to be operated by using compressed air, wherein the air pressure is between 2 and 10 bar. In some embodiments, the air pressure is between 5 and 7 bar.

The body 20 of the air hoist 10 is at the top end 23 thereof, provided with a connector 30. The connector in the example of FIG. 1 has the shape of a hook 30. This hook 30 is typically adapted to connect the air hoist 10 to a support, such as a ring. In the use of the air hoist 10 in a shipyard, this hook 30 can, for instance, be connected to a temporary lug fixed to the hull the ship.

A lifting cable or chain 40 passes through the body 20 of the air hoist 10. The chain 40 is adapted to be raised or lowered by means of the pneumatic motor inside the body 20 of the air hoist 10.

The lifting chain 40 is provided with the first stop 41 and a second stop 42. These stops 41, 42 serve as safety means to prevent the chain 40 from running too far into the body 20 and thereby damage the body 20 of the air hoist 10.

It will be understood that only part of the chain 40 length is shown in FIG. 1, for clarity reasons. A first end of the chain 40 is connected to an adapted connector 24 present at the outside of the body 20 of the air hoist 10. The second end of the chain 40 is provided with a connector in the form of a hook 50. The hook 50 is adapted to be connected to a load. In use, this load can be raised or lowered with respect to the connection of the hook 30 of the air hoist 10.

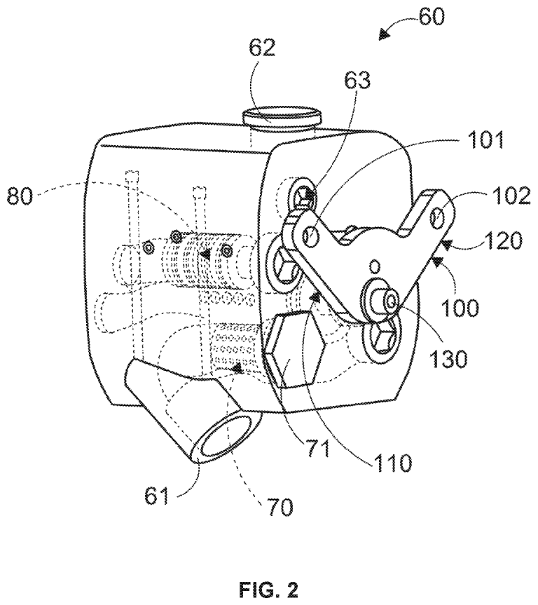

FIG. 1 shows that the body 20 of the air hoist 10 comprises a first end 21 and an opposite, second end 22. The first end 21 of the body 20 is provided with a control unit 60, which will be described in detail with reference to FIG. 2.

FIG. 2 shows a control unit 60 for the air hoist 10 according to FIG. 1. The control unit 60 comprises several elements to perform a combination of functions. The control unit 60 comprises an air entry 61 which is adapted to be connected to the end of an air host which is used to connect the air inlet 61 to a source of compressed air. It is noted that, for clarity reasons, the air hose is not shown in FIG. 2.

From the air entry 61 of the control unit 60, the compressed air will be guided inside the control unit 60 towards the air inlet of the pneumatic motor positioned inside the body 20 of the air hoist 10 (see FIG. 1).

For clarity reasons, the exterior of the control unit 60 according to the example of FIG. 2 is partly represented as being transparent. In practise, the control unit 60 will comprise an opaque metal housing which provides the control unit 60 with a certain robustness to protect the control unit 60, and its components, during storage, transport and use.

From the air entry 61 the incoming, compressed air will be guided towards an air filter 70. This air filter 70 is directly connected to the air inlet 61. This means that all incoming air, before being forwarded to the inlet of the pneumatic motor of the air hoist 10, will automatically be filtered by means of the filter 70. Therefore, in the air hoist 10 of the disclosure, it is not possible to forward unfiltered air to the air inlet of the pneumatic motor.

In embodiments where the control unit 60 is used as an integral part of the air hoist body 20, the presence of the air filter 70 prevents unfiltered air from entering the pneumatic motor of the air hoist 10. In embodiments in which the control unit 60 is used as a separate component of the air hoist 10, the absence of the control unit 60 will make it impossible for a user to connect a hose for compressed air to the air hoist 10. That means that in case of absence of the control unit 60, a user must first connect a control unit 60 to the air hoist body 20 before they is able to connect an air hose.

The filter 70 is provided with an opening/closing device 71, which is easily accessible from the outside of the control device 60. This opening/closing device 71 is adapted to provide direct access to the filter 70 to allow easy inspection, cleaning or replacement of the filter 70.

Filter 70 is typically adapted to filter particles with an average particle size between 100 to 600 microns, although typically around 400 microns. The specific filter that will be selected by a user may depend on the pneumatic motor used inside the body 20 of the air hoist 10 and the specific air conditions in the environment where the air hoist 10 is used.

The control unit 60 further comprises an overload protection 80. This overload protection 80 typically comprises a stainless-steel piston that slides in a brass cylinder. The cylinder is connected to a spring that exerts a determined force on the cylinder. The spring keeps the overload protection in a first, opening position to allow the chain to move with respect to the hoist body 20.

The functioning of the overload protection is as follows: in case a user would like to lift a load that is too heavy for the air hoist, the piston slides inside the cylinder against the spring force. This movement will trigger a brake circuit, and the overload protection will move to a second, brake position in which a brake engages to stop the chain 40 to move.

This means that the control unit 60 comprises an automatic safety protection to avoid raising loads that are not adapted for the air hoist 10.

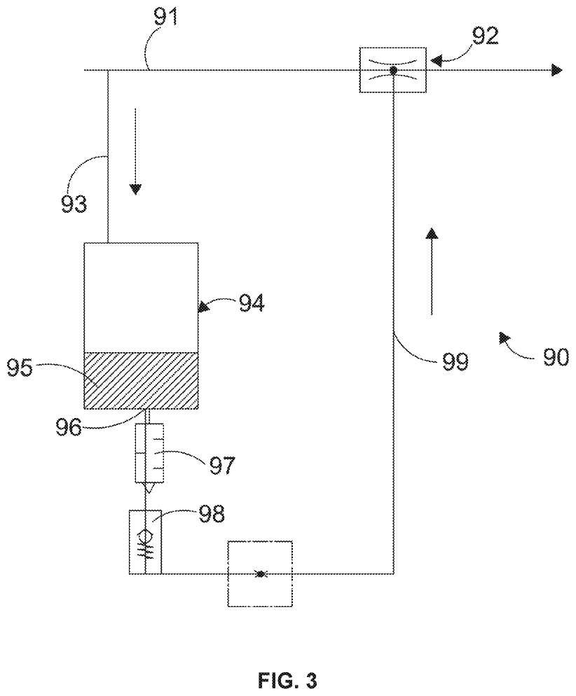

The control unit 60 further comprises an integrated air lubrication system 90. As shown in FIG. 2, the lubrication system 90 comprises a filler cap 62 and an inspection window 63. The functioning of the lubrication device 90 is shown in detail in FIG. 3.

FIG. 3 schematically shows the lubrication system 90 of the air hoist 10 according to FIG. 1. The lubrication system 90 is present inside the control unit 60 of FIG. 2. The compressed air, downstream from the filter 70, is supplied to the lubrication system 90 via line 91.

Line 91 guides the compressed air to a venturi-module 92. The functioning of such a venturi-module 92 is known and will not be explained in detail in this description. The venturi-module 92 is adapted to allow a determined amount of oil to be dispersed to the compressed air in line 91, upstream from the pneumatic motor of the air hoist 10.

The line 91 is further connected to a second line 93, which connects with an oil tank 94. In the example of FIG. 3, the oil tank 94 is partly filled with oil 95. Due to the presence of the air pressure in the line 93, a certain air pressure is built up in the oil tank 94, allowing the oil 95 to be pushed towards the exit 96 of the oil tank 94. With reference to FIG. 2, it is noted that the interior of the oil tank 94 can be inspected via the inspection window 63.

The exit 96 of the oil tank 94 is connected to a regulator 97 which is used to control the flow rate of the oil 95 in the direction of line 99. The regulator 97 is connected to a non-return valve 98. Downstream of the non-return valve 98, the oil 95 flows via line 99 in the direction of the venturi-module 92. According to a known principle, which is not further discussed in detail in this disclosure, droplets of oil 95 will be taken up by the air flow through the line 91. Via the line 91, the lubricated, compressed air flow will flow in the direction of the pneumatic motor inside the body 20 of the air hoist 10.

The presence of the lubrication system 90, as described above, causes all the air flowing through to the pneumatic motor to be lubricated. This allows for safe operation of the air hoist 10.

The control unit 60 further comprises a control valve arm 100, which has essentially the shape of a W. Each of the outer legs 110, 120 of the control valve arm 100 comprises a hole 101, 102. The holes 101, 102 are adapted to fix control wires. These control wires are not shown in FIG. 2 but can comprise any adapted wire or rope that can transmit sufficient force to cause the control valve arm 100 to rotate over the rotation axis 130 from a first position to lift a weight, via a neutral position to a third position to lower a weight. The advantage of using control wires is the fact that the length of the control wires can easily be modified, since the control wires do not comprise any integrated controls.

In the example of FIGS. 1, 2 and 3, the air hoist 10 is not provided with an air pressure regulator. It will be understood that, according to an alternative embodiment of the description, the control unit 60 could be provided with such an air pressure regulator.

Returning to FIG. 1, it is noted that in use, the top fixing element or hook 30, the chain 40 and the hook 50 are essentially positioned in line on the vertical Y, as shown in FIG. 1. The part of the air hoist body 20 comprising the pneumatic motor, is substantially positioned on one side of this vertical Y, while the control unit 60 is positioned on the opposite side of the vertical Y. This means that due to the configuration of the air hoist 10 according to the disclosure, the weight of the air hoist 10 is balanced with respect to the vertical Y.

This written description uses examples to disclose the various embodiments described herein and also to enable any person skilled in the art to practice the various embodiments. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An air hoist, comprising:
an air hoist body with a pneumatic motor and a cable or chain for connecting a load, the pneumatic motor having an air intake and an air outlet for respectively letting in and letting out compressed air, the pneumatic motor configured to move the cable or chain with respect to the air hoist body; and
a control unit comprising a control valve arm configured to move from a neutral position to either a first position to allow the pneumatic motor to turn in a first direction, or a second position to allow the pneumatic motor to turn in a second direction opposite to the first direction, the control valve arm having a first connector and a second connector to connect respectively a first and a second pull rope to move the control arm to a selected position, the control unit comprising an air entry, the control unit configured to guide compressed air from the air entry toward the air inlet of the pneumatic motor, the control unit comprising an air filter positioned downstream from the air entry and upstream from the air inlet of the pneumatic motor.

2. The air hoist of claim 1, wherein the contro unit further comprises a lubrication system configured to lubricate an air flow through the control unit.

3. The air hoist of claim 2, wherein the lubrication system is positioned downstream from the filter and upstream from the air inlet of the pneumatic motor.

4. The air hoist of claim 1, wherein the control unit further comprises an air pressure regulator.

5. The air hoist of claim 1, wherein the control unit further comprises an overload protection with a first, opening position to allow the cable or chain to move with respect to the air hoist body and a second, brake position to avoid the cable or chain to move with respect to the air hoist body, wherein the overload protection moves to the second brake position when the tension on the cable or chain exceeds a predetermined threshold.

6. The air hoist of claim 5, wherein the overload protection further comprises an assembly of a piston, a cylinder, and a spring, the piston configured to move from the first, opening position of the overload protection towards the second, brake position of the overload protection via pressure exerted on the piston due to the air flow through the control unit.

7. A control unit for an air hoist, the air hoist including an air hoist body with a pneumatic motor and a cable or chain for connecting a load, the pneumatic motor having an air intake and an air outlet for respectively letting in and letting out compressed air, the pneumatic motor being adapted to move the cable or chain with respect to the air hoist body, the control unit configured to be connected to the air hoist body and is adapted to guide compressed air to the air inlet of the pneumatic motor of the air hoist, the control unit comprising:
a control valve arm configured to move from a neutral position to either a first position to allow the pneumatic motor to turn in a first direction or a second position to allow the pneumatic motor to turn in a second direction opposite to the first direction, the control valve arm having a first connector and a second connector to connect respectively a first and a second pull rope to move the control arm to a selected position;
an air entry and an air filter, wherein the air filter is positioned downstream from the air entry;
an air filter positioned downstream from the air entry and an air exit, wherein the air exit of the control unit is configured to be connected to the air inlet of the pneumatic motor of the air hoist.

8. The control unit of claim 7, further comprising a lubrication a lubrication system configured to lubricate an air flow through the control unit.
